(19) United States
(12) Patent Application Publication
(10) Pub. No.: US 2020/0300343 A1
(43) Pub. Date: Sep. 24, 2020

(54) LINEAR ACTUATORS

(71) Applicant: CLAVERHAM LIMITED, Shirley (GB)

(72) Inventor: Suat Bekircan, Combe Down Bath and North East Somerset (GB)

(21) Appl. No.: 16/708,492

(22) Filed: Dec. 10, 2019

(30) Foreign Application Priority Data
Mar. 23, 2019 (EP) 19164773.4

(51) Int. Cl. F16H 25/22

(52) U.S. Cl. CPC F16H 25/2223; F16H 25/2418; F16H 25/2228

(57) ABSTRACT

A linear electromechanical actuator comprises an electric motor, a ball screw shaft driven by the electric motor and a tubular output shaft receiving the ball screw shaft and rotationally coupled thereto. The ball screw shaft has at least one helical groove formed on a radially outer surface thereof and the output shaft has at least one helical groove formed in a radially inner surface thereof. A plurality of ball elements is received within the grooves for rotationally coupling the ball screw shaft to the output shaft. The ball screw shaft further comprises a ball recirculation element mounted in the radially outer surface of the ball screw shaft. The ball recirculation element interrupts the helical groove in the ball screw shaft and has one or more ball recirculating passages. Each ball recirculating passage comprises an inlet portion a recirculation portion and an outlet portion.

### FOREIGN PRIORITY

This application claims priority to European Patent Application No. 19164773.4 filed Mar. 23, 2019, the entire contents of which is incorporated herein by reference.

### TECHNICAL FIELD

The present disclosure relates to linear actuators and in particular to electromechanical linear actuators. Such actuators may be used to actuate control and other surfaces in aircraft, for example slats, flaps, thrust reverser doors and so on.

### BACKGROUND

Presently such actuators typically comprise a ball screw shaft which is driven by an electric motor, for example a brushless DC motor. The ball screw shaft drives an output piston through a ball nut which is mounted to the output piston. The balls of the ball screw are recirculated through recirculation passages formed in the nut. Lubricant is typically retained within the ball nut by scraper seals formed between the grooves of the ball screw shaft and the ball nut.

While such a construction provides satisfactory operation, the radial dimensions of the actuator may be relatively large and the actuator may need regular servicing to maintain lubricant in the region of the ball nut. In the aerospace industry at least, size is a significant factor, as is the desire to reduce the mean time between overhaul of components.

### SUMMARY

In accordance with the disclosure there is provided a linear electromechanical actuator which comprises an electric motor, a ball screw shaft driven by the electric motor and a tubular output shaft receiving the ball screw shaft and rotationally coupled thereto. The ball screw shaft has at least one helical groove formed on a radially outer surface thereof and the output shaft has at least one helical groove formed in a radially inner surface thereof. A plurality of ball elements is received within the grooves for rotationally coupling the ball screw shaft to the output shaft. The ball screw shaft further comprises a ball recirculation element mounted in the radially outer surface of the ball screw shaft. The ball recirculation element interrupts the helical groove in the ball screw shaft and has one or more ball recirculating passages. Each ball recirculating passage comprises an inlet portion a recirculation portion and an outlet portion. The inlet portion deflects balls into the recirculation portion from a first portion of the helical groove and the outlet portion deflects balls from the recirculation portion back into a second portion of the helical groove.

The recirculation portion may comprise a passage which extends around a radially outer circumferential portion of the ball screw shaft radially inwardly of the radially outer surface of the ball screw shaft to thereby recirculate the balls from the first portion of the helical groove to the second portion of the helical groove through a radially outer portion of the ball screw shaft.

The ball recirculation element may be mounted in a slot or groove formed in the radially outer surface of the ball screw shaft.

The ball recirculation element may be press fitted, bonded or fastened into the slot or groove.

The inlet and outlet portions of the ball recirculation passage may project into the groove of the output shaft to deflect balls therefrom into the recirculation passage.

The inlet and outlet portions of the ball recirculation passage may be curved.

The recirculation portions of the ball recirculation passage may, in projection, be straight and have an axis which arranged at an angle to the longitudinal axis of the ball screw shaft.

The ball recirculation element may be formed as a unitary, one piece body.

In an alternative arrangement, the ball recirculation element may comprise two components joined together, the ball recirculation passage being formed at the interface of the two components.

The output shaft may comprise a distal end remote from the motor and a proximal end closer to the motor. The distal end of the output shaft may be closed, optionally by a connecting eye for attaching the output shaft (8) to an element to be actuated. The actuator may further comprise a seal between the proximal end of the output shaft and a cylindrical, ungrooved portion of the ball screw shaft to retain lubricant in a chamber formed between the seal and the closed end of the output shaft and in which the grooved portion of the ball screw shaft is arranged.

The seal may be mounted in a groove formed in a radially inner surface of the proximal end of the output shaft.

The seal may be a garter seal.

The actuator may further comprise a housing receiving the motor, the output shaft being slidably mounted within a bore of the motor housing.

A scraper seal and/or a linear bearing may be mounted between the housing and a radially outer surface of the output shaft.

A torque reactor may be provided between the housing and the output shaft.

### BRIEF DESCRIPTION OF DRAWINGS

Some embodiments of the disclosure will now be described by way of example only with reference to the accompanying drawings in which;

FIG. 1 shows an actuator in accordance with the disclosure;

FIG. 2 shows a detail of the ball screw shaft of the actuator of FIG. 1;

FIG. 3 shows a schematic cross-section along the line A-A of FIG. 2;

FIG. 4 shows a schematic cross-section of a first embodiment of actuator in accordance with the disclosure taken along a line corresponding to line B-B of FIG. 2;

FIG. 5 shows a schematic cross-section a second embodiment of actuator in accordance with the disclosure taken along a line corresponding to line B-B of FIG. 2; and

FIG. 6 shows an alternative construction of ball recirculation element.

### DETAILED DESCRIPTION

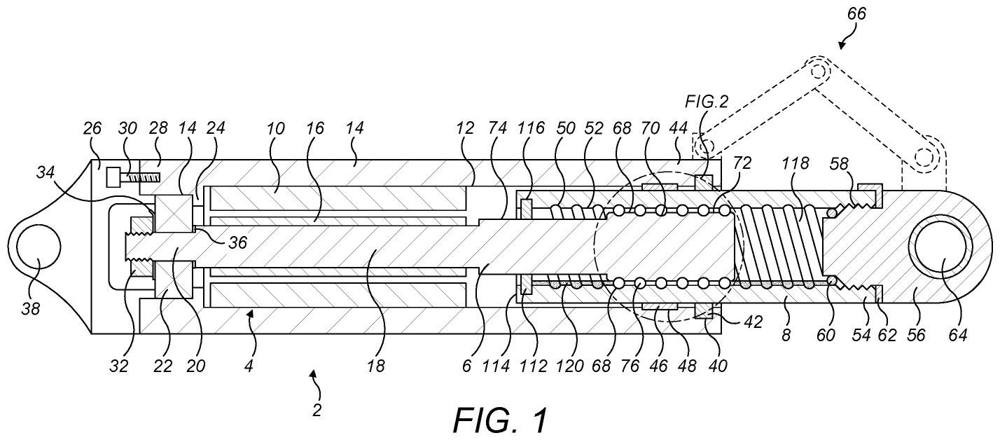

With reference to FIG. 1, an electromechanical actuator 2 comprises a motor 4, a ball screw shaft 6 driven by the motor 4 and an output shaft 8 driven by the ball screw shaft 6.

The motor 4 is, in this embodiment, a brushless DC motor comprising a stator 10 mounted in a bore 12 of a motor housing 14 and a rotor 16 mounted on a portion 18 of the ball screw shaft 6. The ball screw shaft 6 is therefore the motor shaft in this embodiment.

One end 20 of the ball screw shaft 6 is supported in the motor housing 14 by means of a bearing 22. The bearing 22 may be a dual row angular contact bearing which may act as a thrust bearing to carry thrust from the output shaft 8 and may be preloaded to eliminate axial play in the actuator 2. The bearing 22 is located against a shoulder 24 of the motor housing 14 and fixed in position by a cap 26 which is mounted to an end 28 of the motor housing 14 by fasteners such as bolts 30. The bearing 22 is retained on the ball screw shaft 6 by means of a nut 32, tab washer 34 and spacer 36.

The cap 26 has an eye 38 which may typically comprise a spherical bearing for attachment to a static structure (not shown) of an aircraft or other structure.

The output shaft 8 is slidably received in the bore 12 of the motor housing 14. To seal the output shaft relative to the motor housing 14, a scraper seal 40 is mounted in a groove 42 at a distal end 44 of the motor housing bore 12. Such types of seal are well known in the art and need not therefore be described in further detail here.

To facilitate sliding of the output shaft 8 in the motor housing bore 12, a linear bearing 46 is provided inboard of the scraper seal 40. In this embodiment, the linear bearing 46 is received in a further groove 48 formed in the motor housing bore 12. The linear bearing 46 may, for example, comprise a sleeve of low friction material such as PTFE.

The output shaft 8 is a tubular element having a helical groove 50 extending along an internal surface of the internal bore 52 of the output shaft 8. A distal end 54 of the internal bore 52 of the output shaft 8 is closed by an eye element 56. The eye element 56 is received in a threaded end portion 58 of the internal bore 52 of the output shaft 8 and the end of the output shaft sealed by an O-ring or similar seal 60. The eye element 56 is locked in position by means of a tab washer or similar 62. The eye element also comprises an eye 64 which may also comprise a spherical bearing for attachment to an element such as a flap, slat or other movable element to be actuated.

A hinged link type torque reactor 66 extends between the distal end 44 of the motor housing 14 and the eye element 56 to prevent the output shaft 8 rotating relative to the motor housing 14. Other forms of torque reactor may be provided.

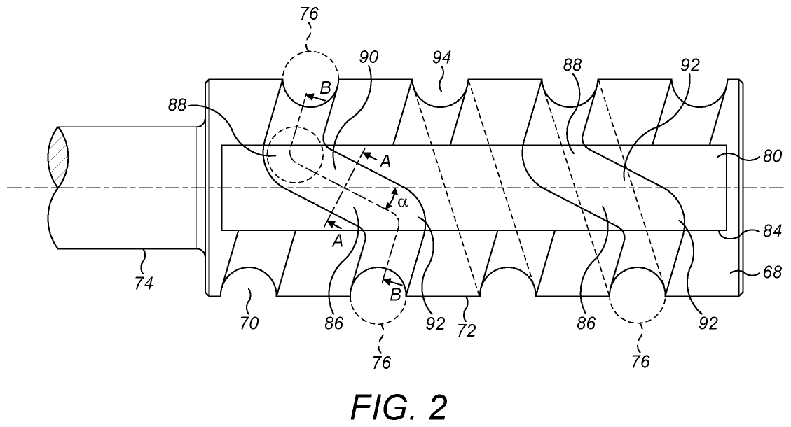

The output shaft 8 is extended from and retracted into the motor housing bore 12 in response to rotation of the ball screw shaft 6 by the motor 4. As can best be seen in FIG. 2, the ball screw shaft 6 comprises a grooved portion 68 which comprises at least one helical groove 70 formed on a radially outer surface 72 of the ball screw shaft 6. The ball screw shaft 6 further comprises an ungrooved, cylindrical portion 74. The pitch and the helix angle of the helical grooves 70, 50 provided on the ball screw shaft 6 and the output shaft 8 are the same.

A plurality of balls 76 are received in the channel formed between the respective helical grooves 50, 70. Rotational movement of the ball screw shaft 6 is transmitted to the output shaft 8 via the balls 76. However, due to the presence of the torque reactor 66, the output shaft 6 cannot rotate and therefore moves linearly into and out of the motor housing 14, depending on the direction of rotation of the ball screw shaft 6. The position of the output shaft 8 may be monitored by one or more sensors (not shown).

The balls 76 must be recirculated to allow proper functioning of the actuator. In existing actuators, this recirculation is normally effected through a nut which is mounted within the output shaft 8. However, in the actuator 2 of the present disclosure, no such nut is provided and recirculation occurs in the ball screw shaft 6. This arrangement is potentially advantageous in that it allows for a reduction in the diameter and therefore size and weight of the actuator 2.

In order to effect recirculation of the balls 76 in the ball screw shaft 6, the ball screw shaft 6 is provided with a ball recirculation element 80 which is mounted in the radially outer surface 72 of the grooved portion 68 of the ball screw shaft. Two embodiments of ball recirculation element 80 are disclosed herein. The first is illustrated in FIGS. 2, 3 and 4 and the second in FIGS. 2, 3 and 5. The two embodiments are generally similar and differ only in certain details which will be discussed further below.

In the embodiments illustrated, the ball recirculation element 80 is mounted in a groove or slot 84 formed in the radially outer surface 72 of the grooved portion 68 of the ball screw shaft 6. The slot or groove 84 may, for example, be machined into the ball screw shaft 6. The ball recirculation element 80 may for example be press fitted bonded or fastened, into the slot or groove 84.

The ball recirculation element 80 interrupts the helical groove 70 of the ball screw shaft 6 and has, in this embodiment, two ball recirculating passages 86. Depending on the particular actuator 2, more or fewer ball recirculating passages 86 may be provided.

Each ball recirculating passage 86 comprises an inlet portion 88, a central recirculation portion 90 and an outlet portion 92. The inlet portion 88 acts to deflect the balls 76 into the recirculation portion 90 from a first portion of the helical groove 70 of the ball screw shaft 6. The outlet portion 92 deflects the balls 76 from the recirculation portion 90 back into a second portion of the helical groove 70. The recirculation element 80 therefore creates a closed recirculating path for the balls 76. In the disclosed embodiment, there are therefore two closed recirculation paths for the balls 76 and the balls 76 will not enter the central groove portions 94, for example.

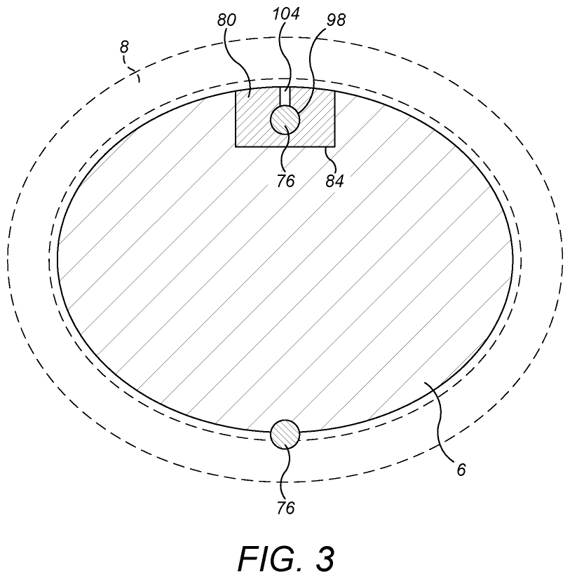

The recirculation portion 90 of the recirculation passage 86 comprises a passage 98 which extends around an outer circumferential portion of the ball screw shaft 6 radially inwardly of the radially outward surface 72. This can be seen most clearly from FIG. 3. This recirculates the balls 76 from the first portion of the helical groove 70 to the second portion of the helical groove 70 through a radially outer portion 100 of the ball screw shaft 6. It will therefore be seen in the embodiments of this disclosure, that the ball recirculation insert 80 is arranged only in the radially outer portion 100 of the ball screw shaft 6. This avoids weakening the ball screw shaft 6 and considerably facilitates manufacture of the ball screw shaft 6 as no bores need to be formed through the ball screw shaft 6 to accommodate the ball recirculation insert 80 or to form recirculation passages within the ball screw shaft 6.

As can be seen in FIG. 3, the insert 80 may be formed as a unitary body 102 having the recirculation passage 86 formed therein. The recirculation passage may be open on its radially outward side as shown to allow lubricant access. For example a slot 104 may be formed in the insert 80 as shown, with a smaller width that the diameter of the balls 76 to retain the balls 76 in the recirculation passage 86. In other embodiments, however, the recirculation passage 86 may be closed on its radially outward side.

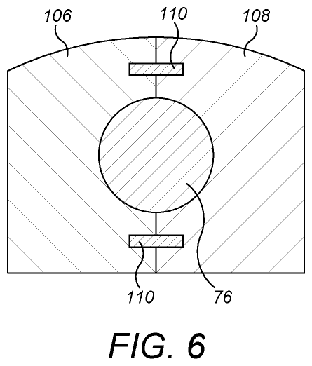

In an alternative embodiment illustrated in FIG. 6, the insert 80 may be formed from two components 106, 108 joined together, the ball recirculation passage 86 being formed at the interface between the two components 106, 108. Dowels 110 may be provided to accurately locate the two components 106, 108 relative to each other. The two components 106, 108 may be joined by any suitable technique for example bonding or by using fasteners. Although shown as closed, the recirculation passage 86 may be radially outwardly open as in the embodiment of FIG. 3.

The insert 80 may be made of any appropriate material. Example materials include plastics, aluminium and bronze, depending on the application. The material may be a low friction material such as PTFE.

The insert 80 may be made by any suitable technique such as moulding, casting, machining or additive manufacturing.

The recirculation passage 86 extends in both circumferential and axial directions around the ball screw shaft 6. As shown, the central recirculation portion 90 of the passage 86 may have an axis A which in projection is a straight line arranged at an angle α to the axis X of the ball screw shaft 6. The angle α may be between 0° and 60°. The inlet and outlet portions 88, 92 curve relative to that axis as shown. The recirculation passage therefore has a shallow S shape in this embodiment. In other embodiment, the recirculation portion 90 may be curved.

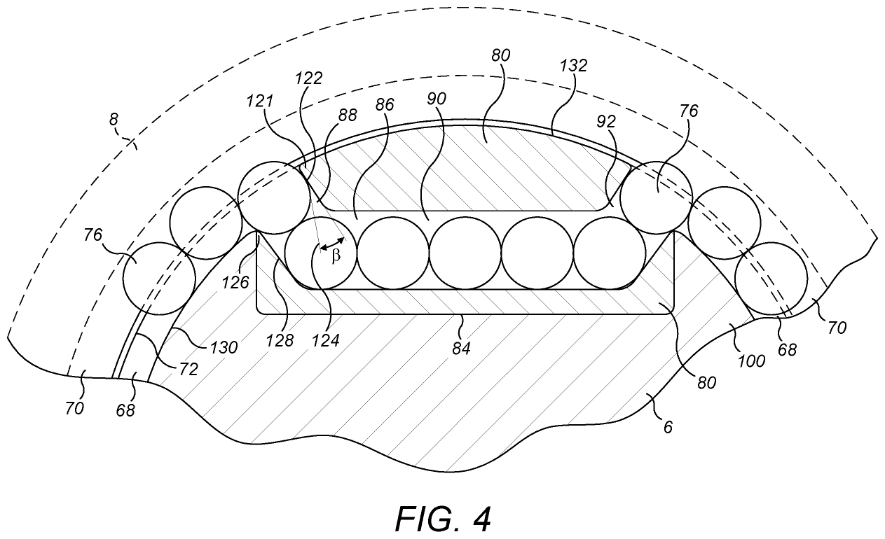

In the embodiment illustrated in FIG. 4, the inlet portion 88 and outlet portion 92 of the recirculation passage 86 open into the radially outer surface 72 of the ball screw shaft 6. In other words, the inlet portion 88 and outlet portion 92 do not protrude into the helical groove 50 of the output shaft 8. The balls 76 are deflected into the recirculation passage 86 by the upper corner 120 of the wall 122 of the inlet portion 88 facing the balls 76. The wall 122 is advantageously inclined at an angle β relative to an axis 124 normal to the radially outer surface 72 of the ball screw shaft 6 to facilitate deflection of the balls 76 into the recirculation passage 86. In various embodiments, the angle may be up to 45°.

The upper corner 126 of the wall 128 of the input portion 86 opposite the wall 122 may, as shown, lie generally flush with the root diameter 130 of the helical groove 68 formed in the ball screw shaft 6. The corner 126 may be curved or smooth to avoid adverse forces being exerted on the balls 76 as they enter the recirculation passage 86.

The radially outer surface 132 of the insert 80 may, as illustrated, lie flush with the radially outer surface 72 of the ball screw shaft 6.

The geometry of the outlet portion 92 of the recirculation passage 86 is, in effect, a mirror image of that of the inlet portion 88, since when the direction of rotation of the ball screw shaft 6 is reversed, it will act as the input portion 88 of the recirculation passage 86.

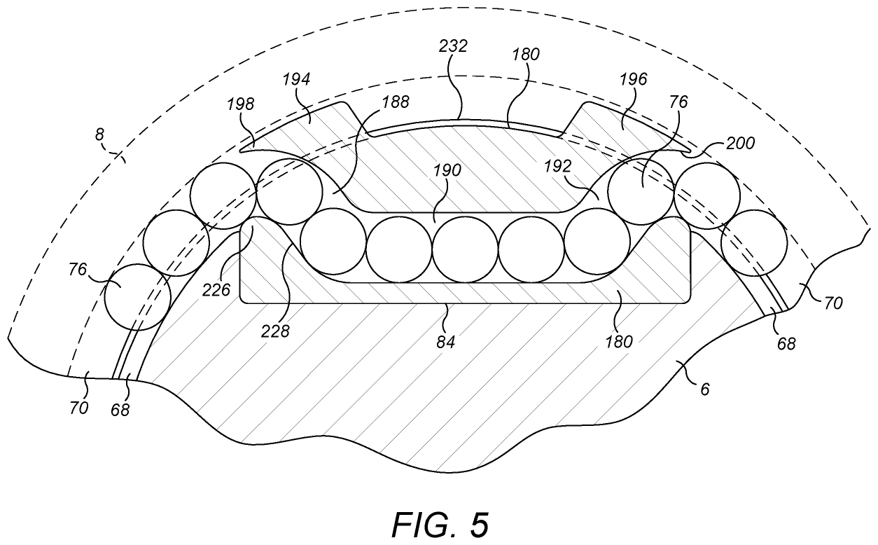

In the embodiment of FIG. 5, to encourage deflection of the balls 76 into the recirculation passage 186 of an insert 180, the inlet portion 188 and outlet portion 192 thereof protrude from the radially outer surface 72 of the grooved portion 68 of the ball screw shaft 6 into the helical groove 70 of the output shaft 8.

The protruding sections 194, 196 of the inlet and outlet portions 188, 192 have curved surfaces 198, 200 so as to provide a smooth transition from the helical groove 70 into the recirculation portion 190 of the passage 186. The remainder of the radially outer surface 232 of the insert 180 may, as illustrated, lie flush with the radially outer surface 72 of the ball screw shaft 6.

The upper corner 226 of the wall 228 of the input portion 186 opposite the protruding section of the inlet portion 188 may, as shown, lie generally flush with the root diameter 130 of the helical groove 68 formed in the ball screw shaft 6. The corner 226 may be curved or smooth to avoid adverse forces being exerted on the balls 76 as they enter the recirculation passage 186.

As in the earlier embodiment, the geometry of the outlet portion 192 of the recirculation passage 186 may be, in effect, a mirror image of that of the inlet portion 188, since when the direction of rotation of the ball screw shaft 6 is reversed, it will act as the input portion 188 of the recirculation passage 186.

The insert 180 of this embodiment may, other than as described above, include the other features of the insert 80 of the first embodiment.

Returning to the overall assembly, it will be seen in FIG. 1 that a seal 112 is provided at a proximal end 114 of the output shaft 8. The seal 112 is received in a groove 116 in output shaft 8. The seal 112 makes sealing contact with the cylindrical, ungrooved portion 74 of the ball screw shaft 6. This forms a chamber 118 between the distal and proximal ends 54, 114 of the output shaft 8 within which the grooved portion 68 of the ball screw shaft 6 rotates. A lubricant 120 is retained in the chamber 118 to lubricate the balls 76 between the ball screw shaft 6 and output shaft 8. The disclosed seal 112 is advantageous compared to earlier constructions as it is made on the ungrooved portion of the ball screw shaft 6 rather than on a grooved portion of the shaft. This retains lubricant more reliably, leading to the need for less maintenance to be performed on the actuator 2.

From the above, it will be seen that the disclosed actuator has a number of significant advantages over conventional actuators. By recirculating the balls 76 through the ball screw shaft 6, a separate nut may be dispensed with, allowing an actuator with fewer parts a smaller diameter and lower weight to be produced. Moreover, the number of components is reduced compared to conventional actuators, thereby providing increased reliability. The inertia of the output shaft is also reduced compared with conventional actuators. This may make the actuator suitable for high frequency operations (for example up to 32 Hz) and small stroke applications (for example up to +/−2.5 cm).

Recirculating the balls through a radially outer region of the ball screw shaft 6 does not compromise the strength of the ball screw shaft 6. In addition, it allows the recirculation path for the balls 76 to be provided by an element 80 which is mounted to an external surface of the ball screw shaft 6 only, considerably facilitating assembly of the actuator. Retention of lubricant is also improved by virtue of the sealing arrangement disclosed, leading to less need for maintenance of the actuator.

It will be appreciated that the description above is of an exemplary embodiment of the disclosure and that modifications may be made to that embodiment within the scope of the disclosure. For example, while a single recirculating insert 80 having multiple recirculation passages is illustrated, individual inserts 80 each providing just one recirculation path may be provided.

1. A linear electromechanical actuator comprising:
an electric motor;
a ball screw shaft driven by the electric motor;
a tubular output shaft receiving the ball screw shaft and rotationally coupled thereto;
wherein the ball screw shaft has at least one helical groove formed on a radially outer surface thereof and the tubular output shaft has at least one helical groove formed in a radially inner surface thereof; and
a plurality of ball elements received within the grooves for rotationally coupling the ball screw shaft to the output shaft;
wherien the ball shaft further includes:
a ball recirculation element mounted in the radially outer surface of the ball screw shaft, the ball recirculation element interrupting the helical groove in the ball screw shaft and having one or more ball recirculating passages,
wherein each ball recirculating passage comprises an inlet portion, a recirculation portion and an outlet portion, the inlet portion deflecting balls into the recirculation portion from a first portion of the helical groove and the outlet portion deflecting balls from the recirculation portion back into a second portion of the helical groove.

2. A linear electromechanical actuator as claimed in claim 1, wherein the recirculation portion comprises a passage which extends around a radially outer circumferential portion of the ball screw shaft radially inwardly of the radially outer surface of the ball screw shaft to thereby recirculate the balls from the first portion of the helical groove to the second portion of the helical groove through a radially outer portion of the ball screw shaft.

3. A linear electromechanical actuator as claimed in claim 1, wherein the ball recirculation element is mounted in a slot or groove formed in the radially outer surface of the ball screw shaft.

4. A linear electromechanical actuator as claimed in claim 3, wherein the ball recirculation element is press fitted, bonded or fastened into the slot or groove.

5. A linear electromechanical actuator as claimed in claim 1, wherein the inlet and outlet portions of the ball recirculation passage project into the groove of the output shaft to deflect balls therefrom into the recirculation passage.

6. A linear electromechanical actuator as claimed in claim 1, wherein the inlet and outlet portions are curved.

7. A linear electromechanical actuator as claimed in claim 1, wherein the recirculation portions of the ball recirculation passage is, in projection, straight and has an axis (A) which arranged at an angle (α) to the axis X of the ball screw shaft.

8. A linear electromechanical actuator as claimed in claim 1, wherein the ball recirculation element is a unitary, one piece body.

9. A linear electromechanical actuator as claimed in claim 1, wherein the ball recirculation element comprises two components joined together, the ball recirculation passage being formed at the interface of the two components.

10. A linear electromechanical actuator as claimed in claim 1, wherein the output shaft comprises a distal end remote from the motor and a proximal end closer to the motor, wherein the distal end of the output shaft is closed, optionally by a connecting eye for attaching the output shaft to an element to be actuated, and wherein the actuator further comprises a seal between the proximal end of the output shaft and a cylindrical, ungrooved portion of the ball screw shaft to retain lubricant in a chamber formed between the seal and the closed end of the output shaft and in which the grooved portion of the ball screw shaft is arranged.

11. A linear electromechanical actuator as claimed in claim 10, wherein the seal is mounted in a groove formed in a radially inner surface of the proximal end of the output shaft.

12. A linear electromechanical actuator as claimed in claim 10, wherein the seal is a garter seal.

13. A linear electromechanical actuator as claimed in claim 1, further comprising a housing receiving the motor, the output shaft being slidably mounted within a bore of the motor housing.

14. A linear electromechanical actuator as claimed in claim 13, comprising a scraper seal or a linear bearing mounted between the housing and a radially outer surface of the output shaft.

15. A linear electromechanical actuator as claimed in claim 13, comprising a torque reactor formed between the housing and the output shaft.
